(19) United States
(12) Patent Application Publication
(10) Pub. No.: US 2024/0362487 A1
(43) Pub. Date: Oct. 31, 2024

(54) SYSTEMS AND METHODS FOR TUNING PARAMETERS OF A MACHINE LEARNING MODEL FOR FEDERATED LEARNING

(71) Applicants: Samsung Electronics Co., Ltd., Suwon-si (KR); University of Southern California, Los Angeles, CA (US)

(72) Inventors: Ahmed Roushdy ElKordy, Los Angeles, CA (US); Sara Babakniya, Los Angeles, CA (US); Qingfeng Liu, San Diego, CA (US); Mostafa El-Khamy, San Diego, CA (US); Yahya Hussain Ezzeldin Essa, Los Angeles, CA (US); Salman Avestimehr, Los Angeles, CA (US)

(21) Appl. No.: 18/646,660

(22) Filed: Apr. 25, 2024

Related U.S. Application Data
(60) Provisional application No. 63/462,175, filed on Apr. 26, 2023.

(51) Int. Cl. G06N 3/082; G06N 3/0455

(52) U.S. Cl. CPC G06N 3/082; G06N 3/0455

(57) ABSTRACT

A system and a method are disclosed for tuning parameters of a large language model. The method comprises identifying first weights of a machine learning (ML) model. Second weights are received from a client device. The second weights may be based on updating, by the client device, the first weights. An update matrix may be generated based on the second weights. The update matrix may be decomposed into first decomposition matrices. Singular values that satisfy a criterion may be identified based on the first decomposition matrices. Singular vectors may be identified based on the singular values. Second decomposition matrices may be identified based on the singular vectors. Updates may be received from the client device of third weights associated with the second decomposition matrices. An updated ML model may be generated based on the updates of the third weights. An inference may be generated based on the updated ML model.

### CROSS-REFERENCE TO RELATED APPLICATION

This application claims the priority benefit under 35 U.S.C. § 119 (e) of U.S. Provisional Application No. 63/462,175, filed on Apr. 26, 2023, the disclosure of which is incorporated by reference in its entirety as if fully set forth herein.

### TECHNICAL FIELD

The disclosure generally relates to federated learning. More

particularly, the subject matter disclosed herein relates to improvements to tuning parameters of a large language model for federated learning.

### SUMMARY

A large language model (LLM) may be pretrained to perform a variety of natural language processing tasks. The pretrained LLM often requires fine-tuning to enhance its performance on a domain specific task. For those tasks that require privacy while fine-tuning, a federated learning paradigm may be employed for fine-tuning the LLM. Federated learning may allow private data that is used for the fine-tuning to be maintained locally on each client edge device, and only share the model updates with a global server.

One issue with fine-tuning an LLM is that it may be computationally expensive as the parameters of the entire model may need to be updated during the fine-tuning. In addition, fine-tuning may also take up the memory resources of the device performing the fine-tuning, which may be challenging for memory-constrained devices (e.g., client devices).

To solve this problem, various parameter efficient fine-tuning mechanisms can be employed for fine-tuning the LLM. Such fine-tuning mechanisms include a Low-Rank Adaptation of Large Language Models (LoRA), Bitfit, and the like. In general terms, LoRA may allow reduction of training time and space by reducing the number of trainable parameters. For example, instead of finetuning the weights of all the parameters of an LLM (also referred to as full fine-tuning), LoRA may fine tune only the weights of the low rank matrices. Bitfit may perform fine-tuning by freezing all the parameters in the pretrained LLM, and only updating the bias terms.

One issue with existing parameter efficient fine-tuning approaches is that although they may help reduce the number of parameters that are fine-tuned, the demand of processing resources and bandwidth overhead required by such mechanisms may still make it impractical for the fine-tuning to be performed by the client devices.

Another issue with applying LoRA for federated learning is that the level of heterogeneity of the training data may increase across users in the federated setting. As the level of heterogeneity increases, the performance gap between fine-tuning using LoRA and full fine-tuning may increase, negatively impacting convergence of the model.

To overcome these issues, systems and methods are described herein for a parameter-efficient fine-tuning of an LLM for federated learning that helps minimize the changes to the parameters of the LLM while reducing communication and computation loads at the client devices. In some embodiments, an improved LoRA mechanism is employed (hereinafter referred to as primed-LoRA) to prime the initial LoRA blocks to be used for performing the fine-tuning of one or more parameters of the LLM. Priming the LoRA blocks may help improve convergence of the LLM, helping reduce communication and computation loads at the client devices.

In some embodiments, the parameter-efficient fine-tuning of the LLM may include a two stage training mechanism that may be identified as a full-tuning for primed LoRA (FLORA) algorithm, or a sparse fine-tuning for primed LoRA (SLORA) algorithm. If the FLORA algorithm is employed, all of the parameters of the LLM are fine-tuned during the first stage of the training, and the LoRA algorithm is run using the primed LoRA blocks during the second stage of the training.

If the SLoRA algorithm is employed, a subset of weights of the LLM are selected using a mask algorithm, and only the subset of the weights is fine-tuned during the first stage of the training, and the LoRA algorithm is run using the primed LoRA blocks during the second stage of the training.

The above approaches improve on previous methods because the parameters of a pre-trained LLM may be fine-tuned, for federated learning, in a way that changes to the parameters of the pre-trained model can be minimized while reducing communication and computation loads at the client devices.

In an embodiment, a method comprises: identifying, by a processor, one or more first weights from a plurality of weights of a machine learning model; receiving, by the processor, one or more second weights from a client device, wherein the one or more second weights are based on updating, by the client device, the one or more first weights; generating, by the processor, an update matrix based on the one or more second weights; decomposing, by the processor, the update matrix into one or more first decomposition matrices; identifying one or more singular values that satisfy a criterion based on the one or more first decomposition matrices; identifying one or more singular vectors based on the identified one or more singular values; generating one or more second decomposition matrices based on the identified one or more singular vectors; receiving, by the processor, from the client device, updates of one or more third weights associated with the one or more second decomposition matrices; generating, by the processor, an updated machine learning model based on the updates of the one or more third weights; and generating, by the processor, an inference based on the updated machine learning model.

According to some embodiments, the identifying of the one or more first weights includes: generating a mask, wherein the mask is configured to select a subset of the plurality of weights.

According to some embodiments, the mask is configured to randomly select the subset of the plurality of weights for one or more layers of the machine learning model.

According to some embodiments, the mask is configured to select the subset of the plurality of weights based on density of one or more layers of the machine learning model.

According to some embodiments, the mask is configured to select the subset of the plurality of weights based on a ranking order of the subset of the plurality of weights.

According to some embodiments, the one or more second decomposition matrices have a rank below a threshold value, wherein the rank determines a total number of the one or more third weights updated by the client device.

According to some embodiments, the decomposing the update matrix into the one or more first decomposition matrices include performing a singular value decomposition of the update matrix for generating a first matrix of the one or more first decomposition matrices, a second matrix of the one or more first decomposition matrices, and a third matrix of the one or more first decomposition matrices, wherein the first matrix includes first singular vectors of the one or more singular vectors, the second matrix includes the one or more singular values, and the third matrix includes second singular vectors of the one or more singular vectors.

According to some embodiments, the one or more second weights are generated by a plurality of client devices, and the method further comprises: aggregating the one or more second weights, wherein the update matrix is based on the aggregated one or more second weights; and transmitting the aggregated one or more second weights to the plurality of client devices.

According to some embodiments, the updates of the one or more third weights are generated by a plurality of client devices, the method further comprising: aggregating the updates of the one or more third weights, wherein the updated machine learning model is based on the aggregated updates of the one or more third weights; and transmitting the aggregated updates of the one or more third weights to the plurality of client devices.

In an embodiment, a computing device is coupled to a client device over a data communications network. The computing device comprises: a processor; and a memory, wherein the memory stores instructions that, when executed by the processor, cause the processor to: identify one or more first weights from a plurality of weights of a machine learning model; receive one or more second weights from the client device, wherein the one or more second weights are based on updating, by the client device, the one or more first weights; generate an update matrix based on the one or more second weights; decompose the update matrix into one or more first decomposition matrices; identify one or more singular values that satisfy a criterion based on the one or more first decomposition matrices; identify one or more singular vectors based on the identified one or more singular values; generate one or more second decomposition matrices based on the identified one or more singular vectors; receive, from the client device, updates of one or more third weights associated with the one or more second decomposition matrices; generate an updated machine learning model based on the updates of the one or more third weights; and generate an inference based on the updated machine learning model.

According to some embodiments, the instructions that cause the computing device to identify the one or more first weights include instructions that cause the computing device to generate a mask, wherein the mask is configured to select a subset of the plurality of weights.

According to some embodiments, the mask is configured to randomly select the subset of the plurality of weights for one or more layers of the machine learning model.

According to some embodiments, the mask is configured to select the subset of the plurality of weights based on density of one or more layers of the machine learning model.

According to some embodiments, the mask is configured to select the subset of the plurality of weights based on a ranking order of the subset of the plurality of weights.

According to some embodiments, the one or more second decomposition matrices have a rank below a threshold value, wherein the rank determines a total number of the one or more third weights updated by the client device.

According to some embodiments, the instructions that cause the processor to decompose the update matrix into the one or more first decomposition matrices include instructions that cause the processor to perform a singular value decomposition of the update matrix for generating a first matrix of the one or more first decomposition matrices, a second matrix of the one or more first decomposition matrices, and a third matrix of the one or more first decomposition matrices, wherein the first matrix includes first singular vectors of the one or more singular vectors, the second matrix includes the one or more singular values, and the third matrix includes second singular vectors of the one or more singular vectors.

In an embodiment, an apparatus comprises: a processor; and a memory, wherein the memory stores instructions that, when executed by the processor, cause the processor to: receive, from a computing device, identification of one or more first weights from a plurality of weights of a machine learning model; update the one or more first weights and generate one or more second weights; receive, from the computing device, identification of one or more third weights associated with an update matrix, wherein the computing device is configured to generate the update matrix based on the one or more second weights, decompose the update matrix into one or more first decomposition matrices, and generate one or more second decomposition matrices based on the one or more first decomposition matrices; update the one or more third weights associated with the one or more second decomposition matrices; and transmit updated ones of the one or more third weights to the computing device for generating an updated machine learning model.

According to some embodiments, the one or more first weights includes a subset of the plurality of weights selected based on a mask.

According to some embodiments, the one or more second decomposition matrices have a rank below a threshold value, wherein the rank determines a total number of the one or more third weights configured to be updated by the processor.

According to some embodiments, the computing device being configured to decompose the update matrix into the one or more first decomposition matrices include performing a singular value decomposition of the update matrix for generating a first matrix of the one or more first decomposition matrices, a second matrix of the one or more first decomposition matrices, and a third matrix of the one or more first decomposition matrices, wherein the first matrix includes first singular vectors, the second matrix includes singular values, and the third matrix includes second singular vectors.

### BRIEF DESCRIPTION OF THE DRAWING

In the following section, the aspects of the subject matter disclosed herein will be described with reference to exemplary embodiments illustrated in the figures, in which:

FIG. 1 depicts an example system for tuning parameters of a machine learning model for federated learning according to one or more embodiments;

FIG. 2 depicts a block diagram of a server according to one or more embodiments;

FIG. 3 depicts a block diagram of a client device according to one or more embodiments;

FIG. 4 depicts a block diagram of a training mechanism using primed-LoRA during a second stage of training according to one or more embodiments;

FIG. 5 depicts a flow diagram of a process for tuning parameters of a machine learning model for federated learning according to one or more embodiments;

FIG. 6 depicts a flow diagram of a first stage of fine-tuning of a machine learning model according to one or more embodiments;

FIG. 7 depicts a flow diagram of a second stage of fine-tuning of a machine learning model according to one or more embodiments;

FIG. 8 depicts a flow diagram of a process for tuning parameters of a machine learning model for federated learning according to one or more other embodiments;

FIG. 9 depicts a block diagram of an electronic device in a network environment according to one or more embodiments; and

FIG. 10 shows a system including a UE and a gNB in communication with each other according to one or more embodiments.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

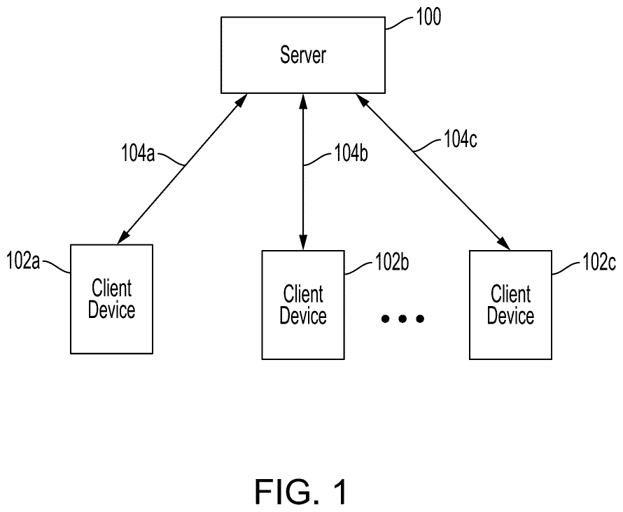

FIG. 1 depicts an example system for tuning or fine-tuning (used interchangeably herein) parameters of a machine learning model for federated learning according to one or more embodiments. As used herein, the term “federated learning” refers to a decentralized approach to training a machine learning model that that keeps local training data private on each client device, and only shares model updates with a global server. Federated learning may also be referred to as collaborative learning.

In some embodiments, the system includes a server 100 coupled to one or more client devices 102a-102c (collectively referenced as 102) over one or more data communication links 104a-104c (collectively referenced as 104). The data communication links 104 may be any wired or wireless link for exchanging data between the server 100 and the client device 102 over a data communications network. The data communications network may include, for example, a local area network, a private wide area network, and/or the public Internet.

The server 100 may be a global server located in a cloud at a single location or at multiple distributed locations. In some embodiments, the server 100 is configured to provide federated machine-learning functionality. In this regard, the server 100 distributes a pre-trained machine learning model (referred to as a “global” or “base” model), to the one or more client devices 102. The global model may be a large language model that has been pretrained on general domain data, although embodiments are not limited thereto. For example, the model may be a generative adversarial network (GAN), variational auto-encoder (VAE), and/or the like.

The global model may be adapted to a particular task or domain by fine-tuning the global model to a particular task or domain. For example, the task or domain may be healthcare, self-driving cars, image analysis, and/or the like. In some embodiments, the global model is fine-tuned by the client devices 102 in a federated learning environment. In this regard, the one or more client devices 102 perform updates of one or more of the pre-trained parameter weights of the global model based on local data collected and/or maintained by the client device 102. In some embodiments, the client device 102 employs a parameter efficient training mechanism such as, for example, LoRA, during at least some of the fine-tuning process. The client device 102 may transmit the updated parameter weights to the server 100 while keeping the local data private. In some embodiments, the server 100 generates a fine-tuned model based on the original global model and the received updates. The fine-tuned model may then be deployed for making inferences based on input data.

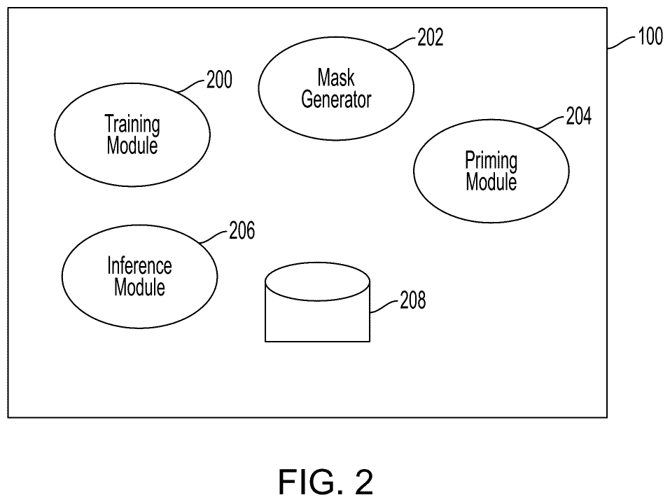

FIG. 2 depicts a block diagram of the server 100 according to one or more embodiments. In some embodiments, the server 100 includes a training module 200, mask generator module 202, priming module 204, and an inference module 206. The various modules 200-206 may be implemented in software, firmware, hardware, or a combination of software, firmware and/or hardware. In this regard, the server 100 may include a memory and a processor. The memory may store instructions that, when executed by the processor, implement the functions of the various modules 200-206. Although the training module 200, mask generator module 202, priming module 204, and inference module 206 are assumed to be separate functional units, a person of skill in the art will recognize that the functionality of the modules may be combined or integrated into a single module, or further subdivided into further sub-modules without departing from the spirit and scope of the inventive concept.

In some embodiments, the server 100 includes a data storage medium 208 for storing the global model with the pre-trained weight values of the parameters of the model. The data storage medium 208 may also store model updates received from the client devices 102. The model updates may include one or more matrices having updated weight values for one or more of the parameters of the model. In some embodiments, the data storage medium 208 further stores the fine-tuned machine learning model which may be generated by combining the global model with the model updates. The data storage medium 208 may include volatile memory, non-volatile memory, removable storage, non-removable storage, and/or the like.

In some embodiments, the training module 200 is configured to fine-tune or adapt (also referred to as train) the global model for federated learning. In some embodiments, the training module 200 orchestrates a two-stage parameter efficient fine-tuning/training mechanism. In some embodiments, in a first stage of the training, one or more of the client devices 102 perform one or more rounds of fine-tuning of the parameter weights of the global model without employing a parameter-efficient training method such as, for example, LoRA. The weights that are tuned during the first stage may be for all of the parameters of the model to achieve full fine-tuning of the model (e.g., if the FLORA algorithm is executed), or a subset of the parameters identified by a mask to achieve sparse fine-tuning of the model (e.g., if the SLoRA algorithm is executed).

In some embodiments, the second stage of the training invokes a parameter efficient tuning mechanism for further fine-tuning one or more parameter weights of the global model. Parameter efficient tuning may generally be achieved by representing the updated weight matrix as a product of two low-rank decomposition matrices, matrix A and matrix B (also referred to as LoRA blocks), and optimizing/training the parameter weights of the decomposition matrices A and B. Fine-tuning the parameters of the low-rank decomposition matrices reduces the number of parameters to be tuned during the second stage of the training.

In a traditional fine-tuning process using LoRA, the decomposition matrix A is initialized using a random Gaussian distribution, and matrix B is initialized with zero values so that the update matrix is zero at the beginning of training. However, initializing the LoRA blocks in a traditional manner in a federated setting where the level of data heterogeneity may be high from client to client may result in decreased performance of the fine-tuning and negatively impact convergence of the model. The decreased performance may result in an increase of communication and computation loads that the client devices.

The challenge of low performance of LoRA fine-tuning may be addressed via the primed-LoRA mechanism that initializes or primes the LoRA blocks based on the update matrix generated based on the first stage of training. In some embodiments, the priming module 204 is invoked to compute the initial vales of the LoRA blocks. In this regard, the priming module 204 may decompose the update matrix into one or more intermediary decomposition matrices. A preset number of vectors from the intermediate decomposition matrices that are predicted to be the most significant may be used to initialize the LoRA blocks. In some embodiments, the decomposing of the update matrix is via a singular value decomposition (SVD), and the preset number of vectors that are selected for initializing the LoRA blocks correspond to the largest singular values stored in one of the intermediary decomposition matrices generated via SVD.

In some embodiments, the mask generator 200 is configured to generate a mask for identifying or selecting parameter weights to be fine-tuned during the first stage of the training process. The mask that is generated may depend on whether the fine-tuning algorithm is FLORA or SLORA. If the fine-tuning algorithm is FLORA, the mask that is generated by the mask generator 200 is configured to select all the parameters of the model for fine-tuning during the first stage. If the fine-tuning algorithm is SLORA, the mask generator 202 employs a masking algorithm for generating a mask that selects a subset of the parameters. In some embodiments, the masking algorithm is configured to generate a uniform mask, majority mask, random mask, and/or the like.

In some embodiments, the mask generator 202 generates a uniform mask by randomly selecting parameters with uniform density for all layers of the global model (e.g., 10% from each of the layers).

In some embodiments, the mask generator 202 generates a majority mask by selecting a subset of clients 102 to perform full fine-tuning locally, and for identifying the most important weights regarding their local datasets. The mask generator 202 is configured to aggregate the individual masks by considering each of them as a binary vote for each weight. For example, if a weight is present in a client's mask, it indicates that the client has voted for that specific weight. After vote aggregation, the mask generator 202 may select the weights with the highest votes. In some embodiments, the mask generator 202 is configured to compute layer-wise densities of participants' votes, and average these densities over all the clients to find an estimation of layer importance. In some embodiments, the mask generator 202 selects the weights with the highest votes layer-wise, from among the aggregated votes.

In some embodiments, the mask generator 202 generates random masking similar to the majority masking process. However, instead of checking the aggregated votes and selecting the final mask among them, the mask generator 202 randomly selects the mask per layer based on the estimated layer importance.

The inference module 206 is configured to make an inference or prediction using the fine-tuned machine learning model. In some embodiments, the fine-tuned model is adapted for a specific task or domain. In this regard, the pre-trained weights of the global model may be combined with the fine-tuned weights of the LoRA blocks for generating the task or domain specific model to be used for the inference.

In making an inference, the inference module 206 receives a word or phrase as an input. The inference module 206 provides the input to the fine-tuned model to generate an inference as an output. The output may be, for example, a predicted word or phrase based on the received input. For example, the inference module 206 may be coupled to a search engine. The input may be a search query into the search engine. The output may be a word or phrase that predicts the user's intent for identifying relevant search results. In other examples, the inference module 206 may generate relevant content based on an input prompt, answer questions entered by a user, and/or the like. In some embodiments, the generated outputs are for specialized tasks, such as tasks related to healthcare, self-driving cars, image analysis, and/or the like.

In some embodiments, the machine learning model used by the inference module 206 may a foundational model other than an LLM. For example, the model may be a generative adversarial network (GAN), variational auto-encoder (VAE), and/or the like.

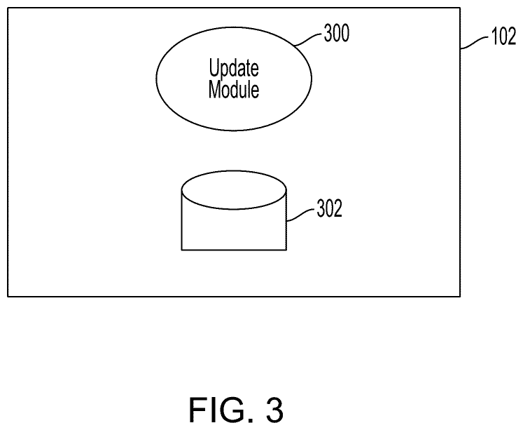

FIG. 3 depicts a block diagram of the client device 102 according to one or more embodiments. In some embodiments, the client device 102 includes an update module 300 and a data storage medium 302. The data storage medium 302 may include volatile memory, non-volatile memory, removable storage, non-removable storage, and/or the like. In some embodiments, the data storage medium 302 stores local training data for locally fine-tuning the global model. The local training data may be, for example, private date related to a specific task or domain. The client device 102 may keep the training data private at the data storage medium 302 without the need to share it with the server 100.

The update module 300 may be configured to fine-tune one or more parameters of the global model based on the local training data. In some embodiments, the update module 300 engages in one of full-fine tuning, sparse fine-tuning, and/or parameter efficient fine-tuning depending on the fine-tuning algorithm and stage of training identified by the server 100. For example, during the first stage of the training, the server 100 may command the update module 300 to perform training of one or more parameters identified via a mask generated by the mask generator 202. The machine learning model may be a neural network represented via one or more matrices of weights associated with one or more layers of the neural network. The update module 300 may be configured to optimize the weights associated with the parameters identified in the mask, during one or more rounds of training during the first stage. The mask my identify all the weights of the model if the training module 200 is configured to execute the FLORA algorithm, or a subset of the weights of the model if the training module is configured to execute the SLoRA algorithm. The updated weights (also referred to as a model update) may be transmitted to the server 100 over the data communication link 104.

In some embodiments, the update module 300 is configured to engage in a parameter-efficient training of the global model during the second stage of training. In some embodiments, the update module 300 employs the LoRA algorithm for training a reduced number of parameters of the model. In this regard, the update module 300 only fine-tunes the weights of the low rank matrices for a given number of training rounds. In some embodiment, the initial values of the low rank matrices are initialized to primed values to help improve convergence of the fine-tuned machine learning model. In some embodiments, the primed values are computed based on decomposition matrices of the update matrix generated based on the first stage of training.

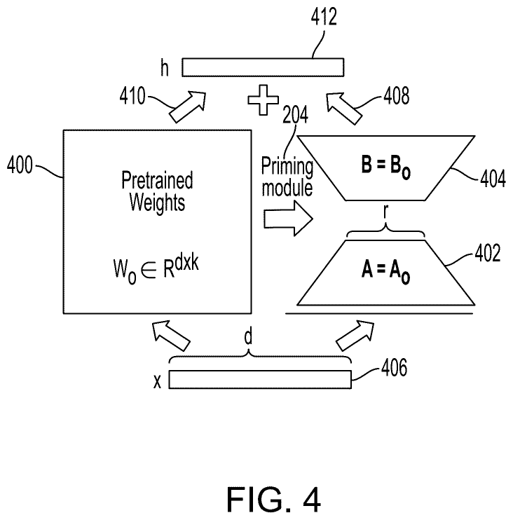

FIG. 4 depicts a block diagram of a training mechanism using primed-LoRA during a second stage of training according to one or more embodiments. In some embodiments, a matrix of pre-trained weights (W₀) 400 of a layer of the global neural network has a dimension of d×k (W₀∈R^{d×k}) resulting from training the global model using, for example, general domain data. In some embodiments, the change of the pre-trained weights (ΔW) may be a low-rank matrix represented via a pair of rank decomposition matrices, matrix A 402 and matrix B 404 as follows:

ΔW=BA, where B∈R^{d×r}, A∈R^{r×k}, and r<<min (k,d), where r is a LoRA rank

In some embodiments, matrix A 402 is initialized by the priming module 204 to a value of A₀, and matrix B 404 is initialized to a value of B₀. The initial values may be computed, for example, using a decomposition mechanism such as, for example, a singular value decomposition (SVD) mechanism. In some embodiments, the SVD decomposition is performed on an update matrix containing the change of the pre-trained weights after performing the first stage of training as follows:

$$Δ {W}_{d \times k} = {U}_{d \times d} {Σ}_{d \times k} {V}_{k \times k}^{T}$$

where U is a matrix of left singular vectors, Σ is a matrix of singular values, and V is a matrix of right singular vectors.

The accurate decomposition of ΔW may not be parameter efficient, and may generate matrices with large dimensions. Thus, according to one embodiment, an approximation of the decomposition is computed so as to preserve, for example, the more significant information of the change matrix. In this regard, the first r columns of U and V matrices which are associated with the largest singular values in Σ may be identified. Matrix A and matrix B may then be computed according to the following formula:

$$A = {U}_{[ 0 : r - 1 ]} {Σ}_{[ 0 : r - 1 ]}^{1 / 2} \\ B = {Σ}_{[ 0 : r - 1 ]}^{1 / 2} {V}_{[ 0 : r - 1 ]}^{T} .$$

In some embodiments, the value r is user configurable (e.g., based on the size of the Σ matrix). The accuracy of the approximation of ΔW increases as the r value increases, but the saving in the parameters decreases. Thus, the value r may be selected to strike a balance between accuracy and parameter savings.

Using the primed values of the LoRA blocks as a starting point, the client device 102 (e.g., via the update module 300) engages in one or more rounds of training using the local data stored in the data storage medium 302, while keeping the original matrix of pre-trained weights 400, unchanged.

In some embodiments, during a forward pass of the training, an input vector 406 x is provided to the matrix of pre-trained weights 400 as well as to matrix A 402. The input vector 406 may be a word or phrase having a length d. The input vector 406 may be received by matrix A 402 and converted to a vector of length r. Matrix B 404 may receive the vector of length r and convert it back to a vector of length d. The output 408 of the processing by matrix B may be combined with the output 410 of the processing by the matrix of pre-trained weights 400, to provide an output h 412 for the current layer of the neural network. The output h 412 may serve as input to a next layer of the neural network.

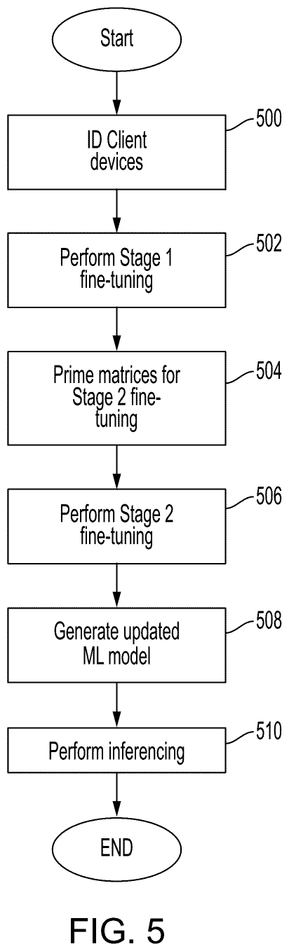

FIG. 5 depicts a flow diagram of a process for tuning parameters of a machine learning model for federated learning according to one or more embodiments. The process starts, and in act 500, the training module 200 identifies a preset number of client devices 102 to participate in the fine-tuning during the first stage. The preset number of client devices 102 may be selected randomly during each round of training.

In act 502, the training module 200 invokes a first stage of fine-tuning of one or more parameters of the model. The first stage of fine-tuning may include fine-tuning all of the parameters of the model, or fine-tuning a subset of the parameters of the model, depending on the fine-tuning algorithm executed by the training module 200 (e.g., FLORA or SLORA). The first stage of fine-tuning may be performed on all or a subset of the layers of the model. For example, in a model having both convolution layers (e.g., for perception) and dense layers (e.g., for attention), the first stage of fine-tuning may be performed on the convolution layers.

In some embodiments, the training module 200 may transmit a command to the identified client devices 102 to engage in the first stage of fine-tuning. The client devices 102 may return updated weights for the one or more parameters of one or more layers of the model, in response to the command. The server 100 aggregates the weight updates from the client devices 102 and generates aggregated updated weights. The aggregated updated weights may be shared with the client devices 102 for updating the model of the client devices 102.

In act 504, the priming module 204 uses the updated weights to calculate the initial values of the LoRA blocks to be used during the second stage of fine-tuning. In some embodiments, the priming module 204 generates an update matrix (ΔW) based on a difference of the aggregated updated weights (W_{R}) from the client devices 102, and the initial pre-trained weights W₀ as follows:

$$Δ W = {W}_{R} - {W}_{O}$$

The priming module 204 may decompose the update matrix (e.g., via SVD), and further compute the initial values for the decomposition matrices A and B based on the decomposed update matrix.

In act 506, the training module 200 invokes a second stage of fine-tuning via one or more of the client devices 102. The second stage of fine-tuning may be performed on all or a subset of the layers of the model. For example, in the above example of a model having both convolution layers and dense layers, the second stage of fine-tuning may be performed on the dense layers.

The same client devices 102 identified in the first stage of training may be invoked for the second stage of training, or different client devices may be identified for the second stage. In some embodiments, the training module 200 transmits a command to the identified client devices 102 to train the LoRA blocks using the initial values of the LoRA blocks computed in act 504, as a starting point. The training may include computing updated weights of the LoRA blocks.

In act 508, the training module 200 may generate an updated model based on the updated weights of the LoRA blocks. For example, the updated model may combine the pre-trained weights of the base model with the updated weights of the LoRA blocks (e.g., for single node/client fine-tuning). In some embodiments, for federated learning with multiple nodes, two or more of the client devices 102 generate the updated weights. The updated weights from multiple nodes may be aggregated at the server 100. The server may share the aggregated updated weights to the individual client devices 102 to update their model before combining with pre-trained weights of the base model.

The updated model may be used for inferencing in act 510. In this regard, the inference module 206 may receive an input vector from a requesting client. The input vector may be processed by the updated model to generate a prediction. The prediction may be provided to the requesting client as an output.

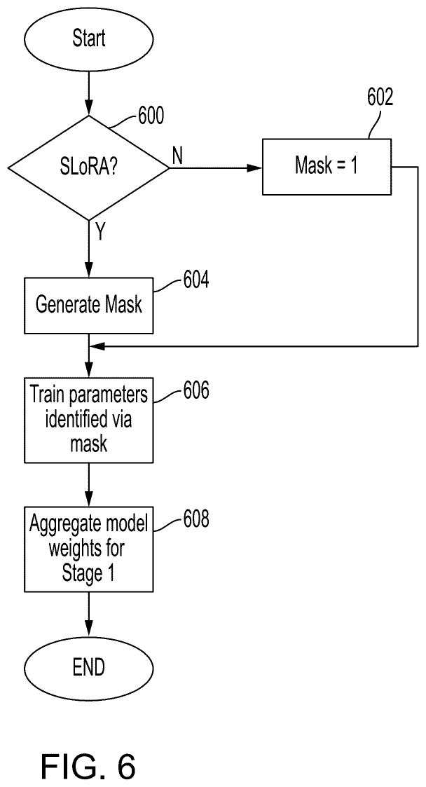

FIG. 6 depicts a flow diagram of the first stage of fine-tuning of the machine learning model according to one or more embodiments. The process starts, and in act 600, the mask generator 202 generates a mask based on whether the fine-tuning algorithm is FLORA or SLORA. In this regard, a determination is made in act 600, as to whether SLoRA is to be executed. If the answer is NO, the algorithm to be executed is FLORA, and the mask is configured to select all the parameters of the model for training during the first stage.

If the answer is YES, and SLORA is set to be executed, the mask generator 202 generates a mask, in act 604, according to a configured masking algorithm. In some embodiments, the mask that is generated is configured to identify a subset of the parameters of the model for training during the first stage. In some embodiments, the masking algorithm generates one of a uniform mask, majority mask, random mask, and/or the like.

In some embodiments, the training module 200 transmits a command to the identified client devices 102 to fine-tune the model weights identified in the generated mask. In some embodiments, the same mask is transmitted to the client devices 102 to fine-tune the model during the first stage of the training.

In act 606, the identified client devices 102 engage in fine-tuning of the model weights identified in the generated mask, based on the local training data stored in the client device. One or more rounds of fine-tuning may be performed by the client devices 102 on one or more layers of the model. The fine-tuning at each round of training may include updating the weights of the parameters identified in the mask, and generating a prediction using the updated weights. The weights may be further modified in each round of training based on the accuracy of the predictions using the current weight values.

In act 608, the training module 200 receives the updated weights from the identified client devices 102 and aggregates the updated weights to generate aggregated updated weights. In some embodiments, an aggregated updated weight of a particular parameter is an average of the weights of the parameter received from the identified client devices 102.

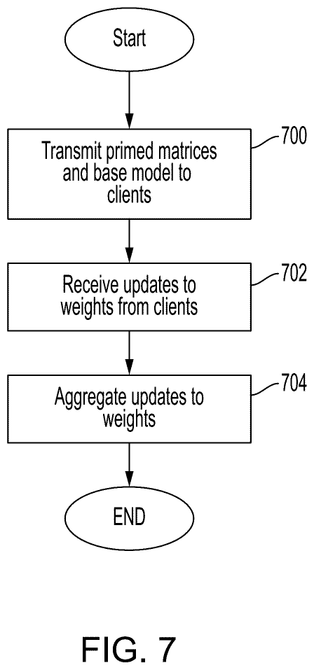

FIG. 7 depicts a flow diagram of the second stage of fine-tuning of the machine learning model according to one or more embodiments. The process starts, and in act 700, the server 100 transmits the primed LoRA blocks and the base model to one or more of the client devices 102.

In act 702, the training module 200 receives updates to one or more weights from the client devices 102. In this regard, the client devices 102 train the primed LoRA blocks in one or more rounds of training for providing the updated weights in the trained LoRA blocks.

In act 704, the training module 200 aggregates the updated weights of the LoRA blocks received from the client devices 102. The aggregate may be an average of the updated weights received from the client devices 102.

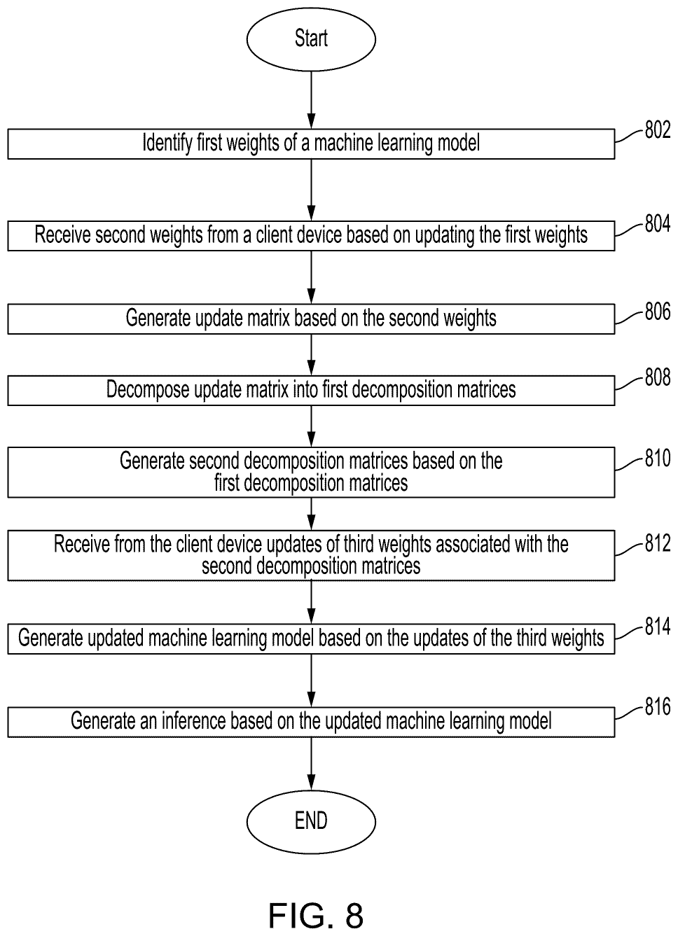

FIG. 8 depicts a flow diagram of a process for tuning parameters of a machine learning model for federated learning according to one or more other embodiments. The process starts, and in act 802, the training module 200 identifies first weights of a machine learning model. The first weights may be weights to be updated during the first stage of training. In some embodiments, the first weights are identified via a mask generated by the mask generator 202. The mask may identify all or a subset of the weights of the model. For example, all of the weights may be identified when the FLORA training algorithm has been selected, but a subset of the weights may be identified when the SLORA training algorithm has been selected.

In act 804, the training module 200 receives second weights from one or more client devices 102. The second weights may be updates of the first weights based on one or more rounds of training by the client devices 102 using local training data.

In act 806, the training module 200 generates an update matrix based on the second weights. The update matrix may be a difference of an aggregate (e.g., average) of the second weights received from the client devices, and the initial weights of the base model.

In acts 808-810, the priming module 204 may be invoked for decomposing the update matrix and computing initial values of the A and B matrices (LoRA blocks) based on the decomposing. In this regard, in act 808, the priming module 204 decomposes the update matrix into first decomposition matrices by taking, for example, the SVD of the update matrix. Using SVD as an example, the first decomposition matrices may include a first matrix (e.g., matrix U) storing first singular vectors, a second matrix (e.g., matrix Σ) storing singular values, and a third matrix (e.g., matrix V^{T}) storing second singular values.

In act 810, the priming module 204 generates second decomposition matrices (e.g., the A and B matrices) based on the first decomposition matrices. The second decomposition matrices may be low-rank matrices (e.g., have a rank below a threshold value). In some embodiments, the priming module 204 computes values of the second decomposition matrices by identifying one or more of the first singular vectors of the first matrix corresponding to singular values of the second matrix that satisfy a criterion (e.g., the largest singular vales). The priming module 204 may further identify one or more of the second singular vectors of the third matrix that correspond to the singular values of the second matrix that satisfy the criterion. The priming module 204 may calculate values of the one or more second decomposition matrices based on the one or more of the first singular vectors and the one or more of the second singular vectors, as follows:

$$A = {U}_{[ 0 : r - 1 ]} {Σ}_{[ 0 : r - 1 ]}^{1 / 2} \\ B = {Σ}_{[ 0 : r - 1 ]}^{1 / 2} {V}_{[ 0 : r - 1 ]}^{T} .$$

In act 812, the training module 200 generates updates of third weights associated with the second decomposition matrices. The third weights may be updates of the weights in the LoRA blocks based on one or more rounds of training using, for example, the LoRA mechanism. The number of third weights that are updated may depend on the rank of the second decomposition matrices.

In act 814, the training module 200 generates an updated machine learning model based on the updated third weights. In some embodiments, the updated machine learning model is an aggregate of the base model and the updated third weights. The updated model may be catered to a particular task or domain.

In act 816, the inference module 206 may receive an input and generate an inference based on the updated machine learning model. The inference may relate to a natural language processing task, although embodiments are not limited thereto. Taking natural language processing as an example, the inference may relate to sentiment analysis, summarization, topic modeling, text classification, keyword extraction, and/or the like.

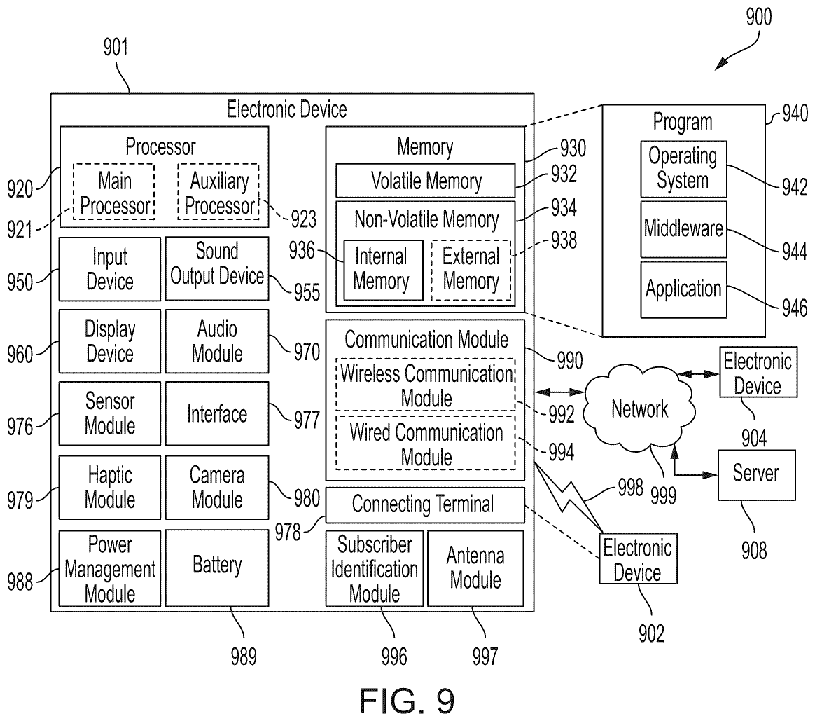

FIG. 9 depicts a block diagram of an electronic device in a network environment 900, according to an embodiment. For example, in some embodiments, server 100 and/or client device 102 of FIG. 1 may be implemented as the electronic device of FIG. 9.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

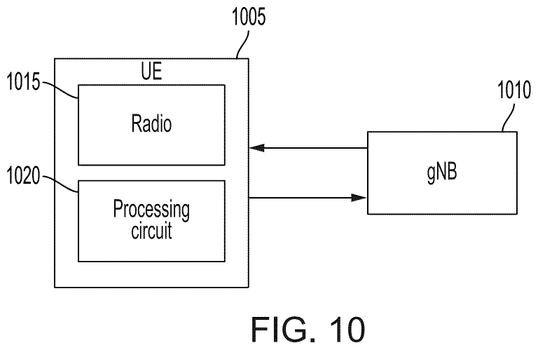

FIG. 10 shows a system including a UE 1005 and a gNB 1010, in communication with each other. The UE may include a radio 1015 and a processing circuit (or a means for processing) 1020, which may perform various methods disclosed herein, e.g., the method described with reference to the training module 200, mask generator 202, priming module 204, inference module 206, and/or update module 300. For example, the processing circuit 1020 may receive, via the radio 1015, transmissions from the network node (gNB) 1010, and the processing circuit 1020 may transmit, via the radio 1015, signals to the gNB 1010.

Embodiments of the subject matter and the operations described in this specification (e.g., the operations described with respect to the training module 200, mask generator 202, priming module 204, inference module 206, and update module 300) may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
identifying, by a processor, one or more first weights from a plurality of weights of a machine learning model;
receiving, by the processor, one or more second weights from a client device, wherein the one or more second weights are based on updating, by the client device, the one or more first weights;
generating, by the processor, an update matrix based on the one or more second weights;
decomposing, by the processor, the update matrix into one or more first decomposition matrices;
identifying one or more singular values that satisfy a criterion based on the one or more first decomposition matrices;
identifying one or more singular vectors based on the identified one or more singular values;
generating one or more second decomposition matrices based on the identified one or more singular vectors;
receiving, by the processor, from the client device, updates of one or more third weights associated with the one or more second decomposition matrices;
generating, by the processor, an updated machine learning model based on the updates of the one or more third weights; and
generating, by the processor, an inference based on the updated machine learning model.

2. The method of claim 1, wherein the identifying of the one or more first weights includes:
generating a mask, wherein the mask is configured to select a subset of the plurality of weights.

3. The method of claim 2, wherein the mask is configured to randomly select the subset of the plurality of weights for one or more layers of the machine learning model.

4. The method of claim 2, wherein the mask is configured to select the subset of the plurality of weights based on density of one or more layers of the machine learning model.

5. The method of claim 4, wherein the mask is configured to select the subset of the plurality of weights based on a ranking order of the subset of the plurality of weights.

6. The method of claim 1, wherein the one or more second decomposition matrices have a rank below a threshold value, wherein the rank determines a total number of the one or more third weights updated by the client device.

7. The method of claim 1, wherein the decomposing the update matrix into the one or more first decomposition matrices include performing a singular value decomposition of the update matrix for generating a first matrix of the one or more first decomposition matrices, a second matrix of the one or more first decomposition matrices, and a third matrix of the one or more first decomposition matrices, wherein the first matrix includes first singular vectors of the one or more singular vectors, the second matrix includes the one or more singular values, and the third matrix includes second singular vectors of the one or more singular vectors.

8. The method of claim 1, wherein the one or more second weights are generated by a plurality of client devices, the method further comprising:
aggregating the one or more second weights, wherein the update matrix is based on the aggregated one or more second weights; and
transmitting the aggregated one or more second weights to the plurality of client devices.

9. The method of claim 1, wherein the updates of the one or more third weights are generated by a plurality of client devices, the method further comprising:
aggregating the updates of the one or more third weights, wherein the updated machine learning model is based on the aggregated updates of the one or more third weights; and
transmitting the aggregated updates of the one or more third weights to the plurality of client devices.

10. A computing device coupled to a client device over a data communications network, the computing device comprising:
a processor; and
a memory, wherein the memory stores instructions that, when executed by the processor, cause the processor to:
identify one or more first weights from a plurality of weights of a machine learning model;
receive one or more second weights from the client device, wherein the one or more second weights are based on updating, by the client device, the one or more first weights;
generate an update matrix based on the one or more second weights;
decompose the update matrix into one or more first decomposition matrices;
identify one or more singular values that satisfy a criterion based on the one or more first decomposition matrices;
identify one or more singular vectors based on the identified one or more singular values;
generate one or more second decomposition matrices based on the identified one or more singular vectors;
receive, from the client device, updates of one or more third weights associated with the one or more second decomposition matrices;
generate an updated machine learning model based on the updates of the one or more third weights; and
generate an inference based on the updated machine learning model.

11. The computing device of claim 10, wherein the instructions that cause the computing device to identify the one or more first weights include instructions that cause the computing device to generate a mask, wherein the mask is configured to select a subset of the plurality of weights.

12. The computing device of claim 11, wherein the mask is configured to randomly select the subset of the plurality of weights for one or more layers of the machine learning model.

13. The computing device of claim 11, wherein the mask is configured to select the subset of the plurality of weights based on density of one or more layers of the machine learning model.

14. The computing device of claim 13, wherein the mask is configured to select the subset of the plurality of weights based on a ranking order of the subset of the plurality of weights.

15. The computing device of claim 10, wherein the one or more second decomposition matrices have a rank below a threshold value, wherein the rank determines a total number of the one or more third weights updated by the client device.

16. The computing device of claim 10, wherein the instructions that cause the processor to decompose the update matrix into the one or more first decomposition matrices include instructions that cause the processor to perform a singular value decomposition of the update matrix for generating a first matrix of the one or more first decomposition matrices, a second matrix of the one or more first decomposition matrices, and a third matrix of the one or more first decomposition matrices, wherein the first matrix includes first singular vectors of the one or more singular vectors, the second matrix includes the one or more singular values, and the third matrix includes second singular vectors of the one or more singular vectors.

17. An apparatus comprising:
a processor; and
a memory, wherein the memory stores instructions that, when executed by the processor, cause the processor to:
receive, from a computing device, identification of one or more first weights from a plurality of weights of a machine learning model;
update the one or more first weights and generate one or more second weights;
receive, from the computing device, identification of one or more third weights associated with an update matrix, wherein the computing device is configured to generate the update matrix based on the one or more second weights, decompose the update matrix into one or more first decomposition matrices, and generate one or more second decomposition matrices based on the one or more first decomposition matrices;
update the one or more third weights associated with the one or more second decomposition matrices; and
transmit updated ones of the one or more third weights to the computing device for generating an updated machine learning model.

18. The apparatus of claim 17, wherein the one or more first weights includes a subset of the plurality of weights selected based on a mask.

19. The apparatus of claim 17, wherein the one or more second decomposition matrices have a rank below a threshold value, wherein the rank determines a total number of the one or more third weights configured to be updated by the processor.

20. The apparatus of claim 17, wherein the computing device being configured to decompose the update matrix into the one or more first decomposition matrices include performing a singular value decomposition of the update matrix for generating a first matrix of the one or more first decomposition matrices, a second matrix of the one or more first decomposition matrices, and a third matrix of the one or more first decomposition matrices, wherein the first matrix includes first singular vectors, the second matrix includes singular values, and the third matrix includes second singular vectors.
